(19) United States
(12) Patent Application Publication
(10) Pub. No.: US 2016/0037384 A1
(43) Pub. Date: Feb. 4, 2016

(54) NON-BLOCKING UPLINK ARCHITECTURE FOR ACCESS POINTS

(71) Applicant: ARUBA NETWORKS, INC., Sunnyvale, CA (US)

(72) Inventors: Abilash Soundararajan, Bangalore (IN); Sridhar Pasupala Chandrasekharan, Bangalore (IN); Srinivas Rao Killadi, Bangalore (IN)

(73) Assignee: ARUBA NETWORKS, INC., Sunnyvale, CA (US)

(21) Appl. No.: 14/445,195

(22) Filed: Jul. 29, 2014

(51) Int. Cl. H04W 28/08; H04L 12/46; H04L 12/709

(52) U.S. Cl. CPC H04W 28/08; H04L 45/245; H04L 12/4633; H04W 80/04

(57) ABSTRACT

The present disclosure discloses a method and a non-blocking uplink architecture for access points augmented by client association based load balancing. Specifically, an access point (AP) can receive a first data set using a particular radio of a plurality of radios, and then transmit the first data set to a network device by: (a) transmitting, to the network device, a first subset of the first data set using a first wired connection between the access point and the network device, and (b) transmitting, to the network device, a second subset of the first data set using a second wired connection between the access point and the network device. Moreover, the AP can select a particular wired connection for transmitting a subset data received from a radio of the AP to the network device, where multiple wired connections exist between the access point and the network device.

### FIELD

Embodiments of the present disclosure relate to optimal distribution of higher distribution of higher bandwidth wireless traffic into aggregated lower bandwidth wired network links. In particular, embodiments of the present disclosure describe a method and network device for access points augmented by client association based load balancing in a non-blocking uplink architecture.

### BACKGROUND

A typical Wireless Local Area Network (WLAN) deployment consists of a collection of Access Points (APs) spread over a geographical area. Each AP can have a number of radios. Each radio may be dedicated to either a 2.4 GHz wireless communication band, or a 5 GHz wireless communication band. The AP may support multiple industry wireless standards, such as IEEE 802.11n, IEEE 802.11ac, etc. Each standard may specify one or more specific wireless communication band to be utilized by a specific protocol. For example, APs in compliance with IEEE 802.11n standard communicate with client devices on both 2.4 GHz and 5 GHz wireless communication bands. However, APs in compliance with the IEEE 802.11ac standard will be communicating with client devices on 5 GHz wireless communication band, but not on 2.4 GHz wireless communication band. Radios in compliance with IEEE 802.11ac standard can support up to 1.3 Gbps throughput, whereas radios in compliance with IEEE 802.11n standard can support up to 450 Mbps throughput.

In addition, each AP can also have one or two wired connections, each of which is connected to a port of an uplink switching device. For example, in an AP with two radios and two uplink 1 GE ports, typically, traffic corresponding to client devices connected to a first radio is transmitted on a first dedicated uplink. Likewise, traffic corresponding to client devices connected to a second radio is transmitted on a second dedicated uplink. Each uplink may support, for example, a maximum of 1 Gbps throughput. Accordingly, a high performance radio, such as a 5 GHz radio supporting 1.3 Gbps throughput, may not be able to reach its full capacity due to the capacity limitation imposed by its dedicated uplink. Meanwhile, a low performance radio, such as a 2.4 GHz radio supporting 450 Mbps throughput, may not fully utilize the capacity provided by its dedicated uplink.

### DETAILED DESCRIPTION

In the following description, several specific details are presented to provide a thorough understanding. While the context of the disclosure is directed to client management in local area networks, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### BRIEF DESCRIPTION OF THE DRAWINGS

The present disclosure may be best understood by referring to the following description and accompanying drawings that are used to illustrate embodiments of the present disclosure.

FIG. 1 shows an exemplary network environment according to embodiments of the present disclosure.

FIG. 2 shows an exemplary network diagram illustrating exemplary uplink architecture according to embodiments of the present disclosure.

FIG. 3 shows another exemplary network diagram illustrating an exemplary uplink architecture according to embodiments of the present disclosure.

FIG. 4 shows an exemplary network diagram illustrating a load balancing scheme according to embodiments of the present disclosure.

FIG. 5 illustrates an exemplary process used in the non-blocking uplink architecture allowing client load balancing with LACP according to embodiments of the present disclosure.

FIG. 6 is a block diagram illustrating an exemplary system for non-blocking uplink architecture allowing client load balancing with LACP according to embodiments of the present disclosure.

### OVERVIEW

Embodiments of the present disclosure relate to client management in local area networks. In particular, embodiments of the present disclosure describe a method and network device for client load balancing when wireless throughput from a radio is more than throughput of one of the aggregated uplinks.

With the solution provided herein, an access point (AP) can receive a first data set using a particular radio of a plurality of radios, and then transmit the first data set to a network device by: (a) transmitting, to the network device, a first subset of the first data set using a first wired connection between the access point and the network device, and (b) transmitting, to the network device, a second subset of the first data set using a second wired connection between the access point and the network device. Moreover, the AP can select a particular wired connection for transmitting a subset data received from a radio of the AP to the network device, where multiple wired connections exist between the access point and the network device.

### Network Environment

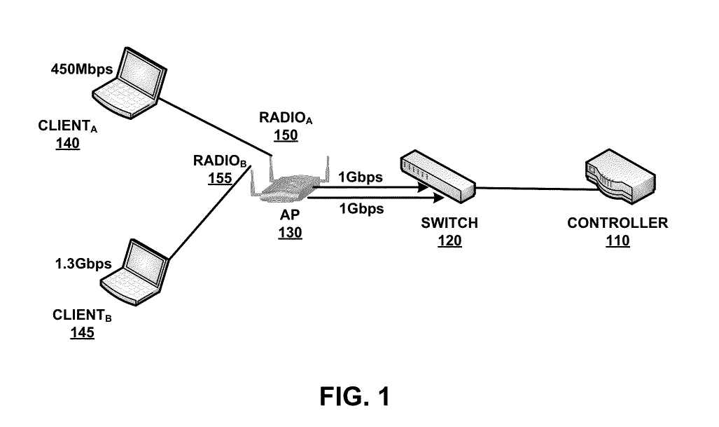

FIG. 1 shows an exemplary network environment according to embodiments of the present disclosure. Specifically, FIG. 1 illustrates a network that includes at least a switch 120, a network controller 110, an access point (AP) 130, and a plurality of client devices, such as Client_{A} 140, Client_{B} 145, etc. AP 130 has at least two radios, e.g., Radio_{A} 150 and Radio_{B} 155. Moreover, AP 130 has at least two uplinks connected to two different ports of switch 120. In the example illustrated in FIG. 1, Radio_{A} 150 has a maximum throughput of 450 Mbps; and, Radio_{B} 155 has a maximum throughput of 1.3 Gbps. Furthermore, assuming that each uplink between AP 130 and switch 120 supports a maximum throughput of 1 Gbps.

Network controller 110 generally refers to a controlling device that manages other network devices such as wireless access points. Network controller 110 may handle automatic adjustments to radio frequency power, wireless channels, wireless authentication, and/or security. Furthermore, network controller 110 can be combined to form a wireless mobility group to allow inter-controller roaming. Network controller 110 can be part of a mobility domain to allow clients access throughout large or regional enterprise facility locations. This saves the clients time and administrators overhead because it can automatically re-associate or re-authenticate.

Switch 120 generally refers to a computer networking device that is used to connect devices together on a computer network by performing a form of packet switching. A switch can send a message only to the port connected to the device that needs or requests the message. A switch is a multi-port network bridge that processes and forwards data at the data link layer (layer-2) of the OSI (Open Systems Interconnection) model. A switch may also have additional features, including the ability to route packets, e.g., as layer-3 or multilayer switches.

Access point 130 generally refers to a wireless network device that allows wireless client devices to connect to a wired network using IEEE 802.11 or related standards. The APs usually connect to a router via a wired network, but can also be an integral component of the router itself.

Each access point serves one or more client devices. Also, each client device and/or access point may connect to another uplink network device (e.g., a network switch and/or controller device) and/or client device via a secure communication channel. For example, in FIG. 1, Client_{A} 140 and Client_{B} 145 are associated with AP 130.

During operations, a mobile client device, such as Client_{B} 145, may transmit a maximum amount of data at 1.3 Gbps data rate through Radio_{B} 155 of AP 130. Another mobile client device, such as Client_{A} 140 may transmit a maximum amount of data at 450 Mbps data rate through Radioₙ 150 of AP 130.

Note that, switch 120 and controller 110 both support Link Aggregation Control Protocol (LACP). The LACP as specified in IEEE 802.3ad standard can bundle individual Gigabit Ethernet links into a single logical link that provides the aggregate bandwidth of multiple physical links. Specifically, a first uplink port of switch 120 may be connected to Eth0 at network controller 110, and a second uplink port of switch 120 may be connected to Eth1 at network controller 110. Controller 110 has two IP addresses, including its own IP address (e.g., IP_ADDR_{X}) and an odd addition of its IP address (e.g., IP_ADDR_{X+1}). During operation, communication tunnels are forwarded by AP 130 based on the source IP address (e.g., IP_ADDR_{Y}) and/or destination IP address (e.g., IP_ADDR_{X} or IP_ADDR_{X+1}) of each received packet using hashing. The same process can be followed by networking equipment switch 120 in its uplink.

In a conventional implementation, a first dedicated uplink with a maximum throughput of 1 Gbps is used for transmission of data received by Radio_{B} 155, and a second dedicated uplink with a maximum throughput of 1 Gbps is used for transmission of data received by Radio_{A} 150. The reasons for this design are: (a) to allow for load balance between client devices operating on 5 GHz and 2.4 GHz wireless communication bands; and (b) to avoid out of order of packet for the same client device. This design works well when there are a good number of client devices operating on both 2.4 GHz and 5 GHz wireless communication bands, because the design will allow for load balancing among such client devices to a certain extent. However, when a network does not have any client devices on the 2.4 GHz wireless communication band, the dedicated uplink associated with the 2.4 GHz radio is not used for transmitting data traffic at all. At the same time, traffic to and from all client devices on the 5 GHz wireless communication band is transmitted on a single dedicated uplink associated with the 5 GHz radio.

Moreover, with the advancement of technologies, the capacity of wireless radio, such as Radio_{B} 155, continues to increase. For example, with multiple spatial streams, a radio may now support up to 1.7 Gbps throughput. As such, the bottleneck caused by uplink capacity limitation in a conventional uplink architectural design can expect to lead to more serious problems in the near future.

### Conventional Uplink Architecture

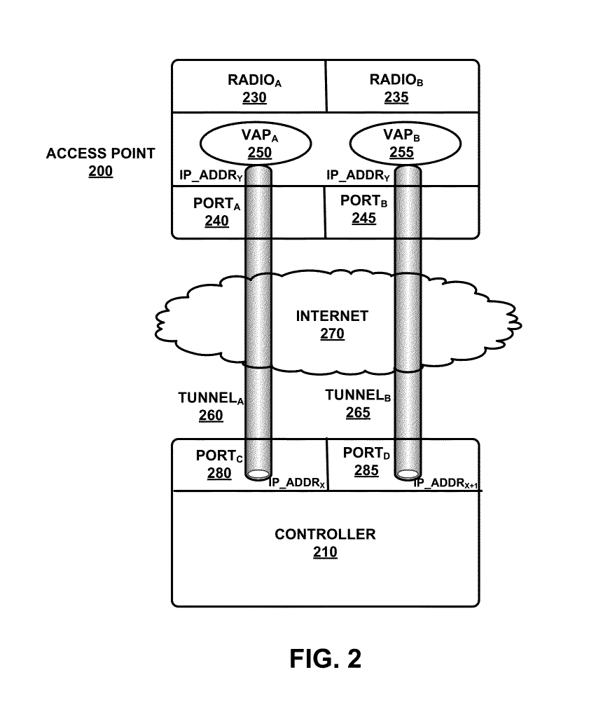

FIG. 2 shows an exemplary network diagram illustrating exemplary conventional uplink architecture according to embodiments of the present disclosure. Specifically, FIG. 2 illustrates a network that includes at least an access point 200 and a network controller 210. In this example, access point 200 is located remote to network controller 210. For example, access point 200 may be located at a satellite office, whereas network controller 210 may be located at a central corporate office. A number of communication tunnels, e.g., Tunnel_{A} 260 and Tunnel_{B} 265, can be established between access point 200 and network controller 210 for transmission of data traffic over Internet 270. A communication tunnel generally refers to a mechanism by which network traffic is encapsulated under a different source and destination address header and transmitted across a private or a public network. In some embodiments, the communication tunnels are secure communication tunnels such as IPSec tunnels. IPSec generally refers to a tunneling protocol that encapsulates a wide variety of network layer protocols inside virtual point-to-point links over an Internet Protocol internetwork. In some embodiments, the communication tunnels are non-secure communication tunnels.

Access point 200 includes at least two radios, namely, Radio_{A} 230 and Radio_{B} 235. Each radio operates at a designated wireless communication band, such as a 2.4 GHz wireless communication band or a 5 GHz wireless communication band. Here, assuming that Radio_{A} 230 operates on the 5 GHz wireless communication band, and Radio_{B} 235 operates on the 2.4 GHz wireless communication band.

Moreover, each radio may be configured to support a virtual access point (VAP). Typically, APs advertise wireless local area networks (WLANs) to wireless client devices by sending out beacons and probe responses that contain the WLAN's service set identifier (SSID) and supported authentication and data rates. When a wireless client device associates to an AP, the client device sends traffic to the AP's BSSID, e.g., as identified by the AP's Media Access Control (MAC) address. It is possible for a single AP to use a unique BSSID for each WLAN. Thus, a physical AP can support multiple WLANs and acts as multiple VAPs. The WLAN configuration as applied to each unique BSSID on a physical AP is generally referred to as a VAP. VAP allows a network administrator to provide different network access or services to users on the same physical network. For example, a first WLAN can be configured to provide access to guest users and a second WLAN to provide access to employee users through the same APs. As another example, a first WLAN can be configured to offer open authentication and Captive Portal access with data rates of 1 and 2 Mbps and a second WLAN that requires WPA authentication can be configured to offer data rates of up to 11 Mbps.

In the example illustrated in FIG. 2, VAP_{A} 250 is configured to support data traffic on 5 GHz wireless communication band, and corresponds to an IP address of IP_ADDR_{Y}. Moreover, VAP_{B} 255 is configured to support data traffic on 2.4 GHz wireless communication band, and corresponds to an IP address of IP_ADDR_{Y}. Data traffic to and from VAP_{A} 250 and its client devices are transmitted via Port_{A} 240. Likewise, data traffic to and from VAP_{B} 255 and its client devices are transmitted via Port_{B} 245.

Network controller 210 also supports multiple Ethernet ports. Specifically, two or more Ethernet ports, such as Port_{C} 280 and Port_{D} 285, can be aggregated to form a single Ethernet group, for example, with Link Aggregation Control Protocol (LACP). IP_ADDR_{X} is assigned to the VLAN. Moreover, one more IP address from the same subnet, e.g., IP_ADDR_{X+1}, can be assigned for a second communication tunnel terminated at network controller 210. The traffic destined to IP_ADDR_{X} and IP_ADDR_{X+1}, can be used to forward traffic through different ports, such as Port_{C} 280 and Port_{D} 285.

A first communication tunnel Tunnel_{A} 260 is established between Port_{A} 240 on AP 200 with IP_ADDR_{Y} and the first Ethernet port on network controller 210 with IP_ADDR_{X} for transmitting data traffic corresponding to 5 GHz wireless communication band. A second communication tunnel Tunnel_{B} 265 is established between Port_{A} 240 on AP 200 with IP_ADDR_{Y} and the second Ethernet port on network controller 210 with IP_ADDR_{X+1} for transmission of secure data traffic corresponding to 2.4 GHz wireless communication band.

### Enhanced Uplink Architecture

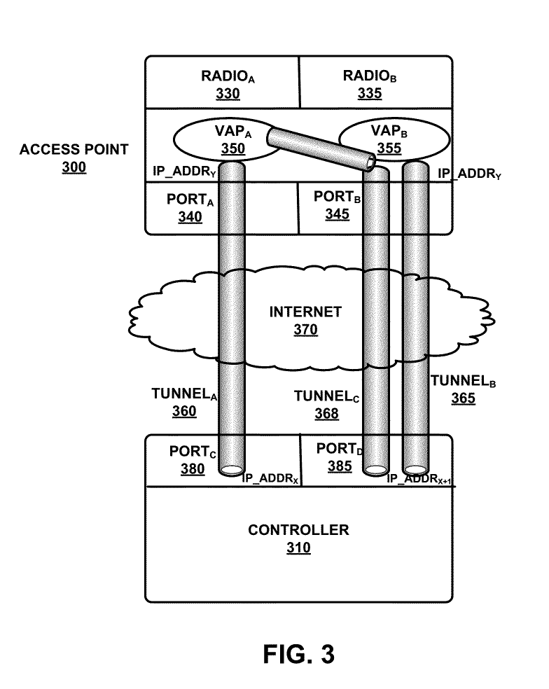

FIG. 3 shows another exemplary network diagram illustrating an exemplary uplink architecture according to embodiments of the present disclosure. Specifically, FIG. 3 illustrates a network that includes at least an access point 300 and a network controller 310. In this example, access point 300 is located remote to network controller 310. For example, access point 300 may be located at a satellite office, whereas network controller 310 may be located at a central corporate office. A number of communication tunnels can be established between access point 300 and network controller 310 for transmission of secure data traffic over Internet 370. In some embodiments, communication tunnels are Generic Routing Encapsulation (GRE) sent inside an IPSec tunnel. IPSec generally refers to a tunneling protocol that encapsulates a wide variety of network layer protocols inside virtual point-to-point links over an Internet Protocol internetwork.

Access point 300 includes at least two radios, namely, Radio_{A} 330 and Radio_{B} 335, and at least two Ethernet ports, namely Port_{A} 340 and Port_{B} 345. Each radio operates at a designated wireless communication band, such as a 2.4 GHz wireless communication band or a 5 GHz wireless communication band. Here, assuming that Radio_{A} 330 operates on the 5 GHz wireless communication band, and Radio_{B} 335 operates on the 2.4 GHz wireless communication band.

Moreover, each radio may be configured to support a VAP. For example, in FIG. 3, VAP_{A} 350 is configured to support data traffic on 5 GHz wireless communication band, and corresponds to an IP address of IP_ADDR_{Y}. Moreover, VAP_{B} 355 is configured to support data traffic on 2.4 GHz wireless communication band, and corresponds to an IP address of IP_ADDR_{Y}. Data traffic to and from VAP_{A} 350 and its client devices are transmitted via Port_{A} 340. Likewise, data traffic to and from VAP_{B} 355 and its client devices are transmitted via Port_{B} 345.

Network controller 310 also supports multiple Ethernet ports. Specifically, two or more Ethernet ports, such as Port_{C} 380 and Port_{D} 385, can be aggregated to form a single Ethernet group, for example, with Link Aggregation Control Protocol (LACP). IP_ADDR_{X} is assigned to the VLAN. Moreover, one more IP address from the same subnet, e.g., IP_ADDR_{X+1}, can be assigned for a second communication tunnel terminated at network controller 310. The traffic destined to IP_ADDR_{X} and IP_ADDR_{X+1} can be used to forward traffic through different ports, such as Port_{C} 380 and Port_{D} 385.

As described above in the conventional uplink architecture, a first communication tunnel Tunnel_{A} 360 is established between Port_{A} 340 on AP 300 with IP_ADDR_{Y} and the first Ethernet port on network controller 310 with IP_ADDR_{X} for transmitting secure data traffic corresponding to 5 GHz wireless communication band. A second communication tunnel Tunnel_{B} 365 is established between Port_{A} 340 on AP 300 with IP_ADDR_{Y} and the second Ethernet port on network controller 310 with IP_ADDR_{X+1} for transmission of secure data traffic corresponding to 2.4 GHz wireless communication band.

However, note that, Radio_{A} 330 may support a maximum of 1.3 Gbps throughput, whereas Port_{A} 340 may have a limit of 1 Gbps throughput. To alleviate the bottleneck problem imposed by the dedicated uplink corresponding to Radio_{A} 330, a third communication tunnel TunnelC 368 is established between VAP_{A} 350 on AP 300 with IP_ADDR_{Y} and the second Ethernet port on network controller 310 with IP_ADDR_{Y+1}. Therefore, secure data traffic corresponding to a high performance radio, e.g., Radio_{A} 330 operating on 5 GHz wireless communication band, now can be distributed over at least two communication tunnels, namely, Tunnel_{A} 360 and Tunnel_{C} 368. Each tunnel supports a maximum throughput of 1 Gbps. On the other hand, secure data traffic corresponding to a low performance radio, e.g., Radio_{B} 335 operating on 2.4 GHz wireless communication band, continues to be transmitted through Tunnel_{B} 365.

Note that, both Tunnel_{B} 365 and Tunnel_{C} 368 have a source address of IP_ADDR_{Y} and a destination address of IP_ADDR_{X+1}. However, in this example, Tunnel_{B} 365 is dedicated to transmit data traffic corresponding to 2.4 GHz wireless communication band, whereas Tunnel_{C} 368 is dedicated to transmit data traffic corresponding to 5 GHz wireless communication band. Because each tunnel is uniquely identified by a tunnel identifier and each tunnel identifier is uniquely mapped to a radio, AP 300 can determine whether to send data traffic to Radio_{A} 330 or Radio_{B} 335 based on the tunnel identifier included in the data packets. Here, the tunnel identifier is clubbed with VAP, which can be based on the MAC address of the radio. Tunnel identifiers are unique numbers when a communication tunnel is established between two endpoints and can be considered as separate logical interfaces. Note that, each radio usually has a unique MAC address, but two radios of the same AP share the same IP address.

### Load Balancing Scheme

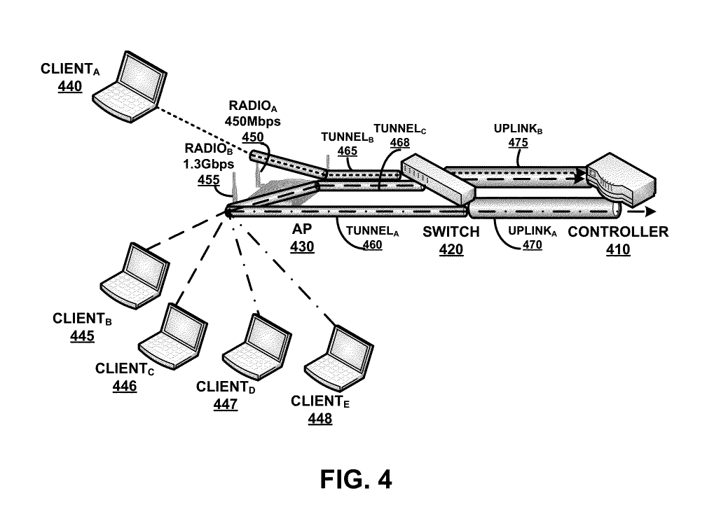

FIG. 4 shows an exemplary network diagram illustrating a load balancing scheme according to embodiments of the present disclosure. Specifically, FIG. 4 illustrate a network that includes at least a switch 420, a network controller 410, an AP 430, and a plurality of client devices, such as Client_{A} 440, Client_{B} 445, Client_{C} 446, Client_{D} 447, Client_{E} 448, etc. For illustration purposes only, assuming that Client_{A} 440 operates on a 2.4 GHz wireless communication band, whereas Client_{B} 445, Client_{C} 446, Client_{D} 447, and Client_{E} 448 all operate on a 5 GHz wireless communication band.

AP 430 may support two or more virtual access pointsw (VAPs). For example, a first VAP may be configured for 2.4 GHz data traffic corresponding to Radio_{A} 450, and a second VAP may be configured for 5 GHz data traffic corresponding to Radio_{B} 455. Furthermore, multiple client devices can be associated with each VAP. As illustrated in FIG. 4, Client_{A} 440 is associated with AP 430 via a wireless connection to Radio_{A} 450 that supports a maximum throughput of 450 Mbps on 2.4 GHz wireless communication band. Moreover, Client_{B} 445, Client_{C} 446, Client_{D} 447, and Client_{E} 448 are associated with AP 430 via connections to Radio_{B} 455 that supports a maximum throughput of 1.3 Gbps on 5 GHz wireless communication band.

In addition, two communication tunnels, namely, Tunnel_{A} 460 and Tunnel_{C} 468, are established between AP 430 and network controller 410 to transmit data traffic corresponding to 5 GHz wireless communication band. Specifically, Tunnel_{A} 460 and Tunnel_{C} 468 share the same source IP address (IP_ADDR_{Y}) but correspond to two different Ethernet ports (IP_ADDR_{Y} and IP_ADDR_{Y+y}) on network controller 410. A third communication tunnel, namely Tunnel_{B} 465, is established between AP 430 and network controller 410 to transmit data traffic corresponding to 2.4 GHz wireless communication band. Tunnel_{B} 465 correspond to a source IP address of IP_ADDR_{Y} and share the same destination address with Tunnel_{C} 468 (IP_ADDR_{X+1}). Each of Tunnel_{A} 460, Tunnel_{B} 465, and Tunnel_{C} 468 is associated with a unique tunnel identifier. Based on the tunnel identifier, AP 430 can determine to which radio between Radio_{A} 450 and Radio_{B} 455 an inbound packet received from a particular tunnel should be forwarded.

Moreover, AP 430 is directly connected to switch 420 via two or more wired connections. Furthermore, switch 420 can have two uplinks, for example, Uplink_{A} 470 and Uplink_{B} 475. Each uplink can terminate at a unique Ethernet port on network controller 410 directly or indirectly via an Internet. Wired ports on switch 420 and network controller 410 both support LACP. In the example, illustrated in FIG. 4, data traffic transmitted over Tunnel_{A} 460 is forwarded to Uplink_{A} 470, whereas data traffic transmitted over Tunnel_{B} 465 and Tunnel_{C} 468 are forwarded to Uplink_{B} 475, and vice versa.

Because both Tunnel_{A} 460 and Tunnel_{C} 468 are dedicated to transmit 5 GHz data traffic, data traffic to/from client devices (e.g., Client_{B} 445, Client_{C} 446, Client_{D} 447, and Client_{E} 448) associated with AP 430 via connections to Radio_{B} 455 can be distributed across the two communication tunnels. In some embodiments, data traffic can be load balanced based on association identifiers. Upon association, each client device is assigned a unique association identification (AID). According to one embodiment, data traffic corresponding to an odd AID are transmitted over Tunnel_{A} 460; and, data traffic corresponding to an even AID are transmitted over Tunnel_{C} 468. For example, in FIG. 4, assuming that AIDs for Client_{B} 445 and Client_{C} 446 are even and AIDs for Client_{D} 447 and Client_{E} 448 are odd. Therefore, traffic associated with Client_{B} 445 and Client_{C} 446 are transmitted over Tunnel_{C} 468; and, traffic associated with Client_{C} 447 and Client_{E} 448 are transmitted over Tunnel_{A} 460.

Note that, although only an exemplary hashing algorithm of AIDs is described here, any load balancing algorithm can be utilized in the same manner. In addition, AP 430 may simply use a round robin algorithm to distribute data traffic associated various client devices connected to the same high performance radio on the same wireless communication band to multiple communication tunnels. For example, data traffic associated with the first two AIDs may be transmitted over Tunnel_{A} 460, and data traffic associated with the next two even AIDs may be transmitted over Tunnel_{C} 468.

Also, data traffic on the same wireless communication band is not necessarily distributed evenly across the multiple communication tunnels. In some embodiments, AP 430 can distribute data traffic associated with Radio_{B} 465 with a 2:1 ratio over Tunnel_{A} 460 and Tunnel_{C} 468. This can ensure that enough portion of the maximum throughput of Uplink_{B} 475 is reserved for data traffic associated with Radio_{A} 450. Therefore, client devices, such as Client_{A} 440, connecting to Radio_{A} 450 on the 2.4 GHz wireless communication band will not be adversely impacted by the load balancing scheme described herein. Specifically, as an example, AP 430 can distribute data traffic associated with first two AIDs to be transmitted over Tunnel_{A} 460 and data traffic associated with the next AID to be transmitted over Tunnel_{C} 468, and repeat the same process for distributing the rest AIDs.

In some embodiments, AP 430 can utilize a load balancing scheme on a per-packet basis rather than distributing data traffic based on AIDs. Packet-based load balancing scheme can be suitable for traffic from network controller 410 to client devices, it may be difficult to distinguish which specific client device is the destination device due to the secure encapsulation. Therefore, a packet-based load balancing scheme can be used to distribute such data traffic received from network controller 410 and destined to client devices without the need to identify the destination client device address and/or association identifier.

Process for Client Load Balancing with Link Aggregation Control Protocol

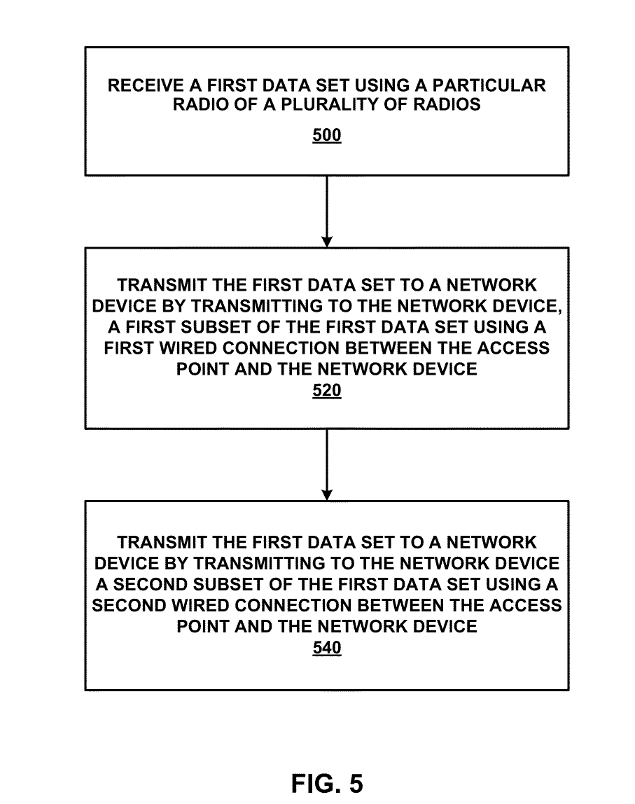

FIG. 5 illustrates an exemplary process used in the non-blocking uplink architecture allowing client load balancing with LACP according to embodiments of the present disclosure. First, a network device, such as an access point, can receive a first data set using a particular radio or a plurality of radios (operation 500). Also, the access point can transmit the first data set to a network device by transmitting, to the network device, a first subset of the first data set using a first wired connection between the access point and the network device (operation 520). Furthermore, the access point transmits, to the network device, a second subset of the first data set using a second wired connection between the access point and the network device (operation 540).

In some embodiments, the access point further receives a second data set using a second radio of the plurality of radios, and transmits, to the network device, the second data set using only one of the first wired connection between the access point and the network device or the second wired connection between the access point and the network device. In some embodiments, the first subset of the first data set is transmitted using a first wired connection via a first encapsulation tunnel; the second subset of the first data set is transmitted using the second wired connection via a second encapsulation tunnel; and, the second data set is transmitting using the second wired connection via a third encapsulation tunnel.

In some embodiments, the first subset of the first data set corresponds to data received from a first set of client devices. Also, the second subset of the first data set corresponds to data received from a second set of client devices.

In some embodiments, the access point further selects one of the first wired connection and the second wired connection for transmitting each subset of the first data set based on a client device from which that subset of the first data set was received. Specifically, the access point can select one of the first wired connection and the second wired connection for transmitting each subset of the first data set based on an Association Identification (AID) of a client device from which that subset of the first data set was received.

Furthermore, in some embodiments, the access point transmits the first subset of the first data set from a first physical port on the access point over the first wired connection to the network device, and transmits the second subset of the first data set from a second physical port on the access point over the second wired connection to the network device. In some embodiments, the first wired connection and the second wired connection are aggregated using a Link Aggregation Control Protocol (LACP).

In some embodiments, the access point selects one of the first wired connection and the second wired connection for transmitting each subset of the first data set using a load balancing algorithm that balances a plurality of data sets transmitted from the access point to the network device across a plurality of wired connections between the access point and the network device.

In some embodiments, the first subset of the first data set identifies a first Internet Protocol (IP) address corresponding to the access point as a source address and a second IP address as a destination address. Further, the second subset of the first data set identifies the first Internet Protocol (IP) address corresponding to the access point as the source address and a third IP address as a destination address. Here, the second IP address and the third IP address correspond to a same device, e.g., a network controller other than the access point.

System for Client Load Balancing with Link Aggregation Control Protocol

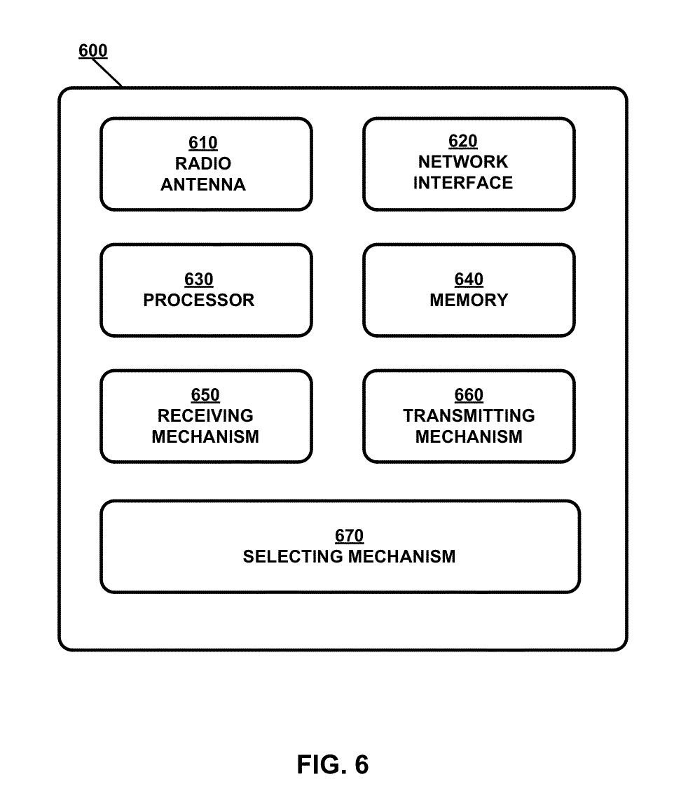

FIG. 6 is a block diagram illustrating a system for allowing client load balancing with LACP in a non-blocking uplink architecture according to embodiments of the present disclosure. Network device 600 includes at least one or more radio antennas 610 capable of either transmitting or receiving radio signals or both, a network interface 620 capable of communicating to a wired or wireless network, a processor 630 capable of processing computing instructions, and a memory 640 capable of storing instructions and data. Moreover, network device 600 further includes a receiving mechanism 650, a transmitting mechanism 660, and a selecting mechanism 670, all of which are in communication with processor 630 and/or memory 640 in network device 600. Network device 600 may be used as a client system, or a server system, or may serve both as a client and a server in a distributed or a cloud computing environment.

Radio antenna 610 may be any combination of known or conventional electrical components for receipt of signaling, including but not limited to, transistors, capacitors, resistors, multiplexers, wiring, registers, diodes or any other electrical components known or later become known.

Network interface 620 can be any communication interface, which includes but is not limited to, a modem, token ring interface, Ethernet interface, wireless IEEE 802.11 interface, cellular wireless interface, satellite transmission interface, or any other interface for coupling network devices.

Processor 630 can include one or more microprocessors and/or network processors. Memory 640 can include storage components, such as, Dynamic Random Access Memory (DRAM), Static Random Access Memory (SRAM), etc.

Receiving mechanism 650 generally receives one or more network messages via network interface 620 or radio antenna 610 from a wireless client. The received network messages may include, but are not limited to, requests and/or responses, beacon frames, management frames, control path frames, and so on. Specifically, receiving mechanism 650 may receive a first data set using a first radio of a plurality of radios, and may receive a second data set using a second radio of the plurality of radios.

Transmitting mechanism 660 generally transmits messages, which include, but are not limited to, requests and/or responses, beacon frames, management frames, control path frames, and so on. Specifically, transmitting mechanism 660 may transmit the first data set to a network device by transmitting a first subset of the first data set using a first wired connection between the access point and the network device, and a second subset of the first data set using a second wired connection between the access point and the network device. Note that, the first subset of the first data set corresponds to data received from a first set of client devices. Further, the second subset of the first data set corresponds to data received from a second set of client devices.

In some embodiments, the first subset of the first data set identifies a first Internet Protocol (IP) address corresponding to the access point as a source address and a second IP address as a destination address. Moreover, the second subset of the first data set identifies the first Internet Protocol (IP) address corresponding to the access point as the source address and a third IP address as a destination address. In some embodiments, the second IP address and the third IP address correspond to a same device, such as a network controller other than the disclosed network device (e.g., an access point).

In some embodiments, transmitting mechanism 660 transmits the second data set using only one of the first wired connection between the access point and the network device or the second wired connection between the access point and the network device.

In some embodiments, the first subset of the first data set is transmitted using a first wired connection via a first encapsulation tunnel. Moreover, the second subset of the first data set is transmitted using the second wired connection via a second encapsulation tunnel, and wherein the second data set is transmitting using the second wired connection via a third encapsulation tunnel.

In some embodiments, transmitting mechanism 660 transmits the first subset of the first data set from a first physical port on the access point over the first wired connection to the network device. Also, transmitting mechanism 660 transmits the second subset of the first data set comprises transmitting from a second physical port on the access point over the second wired connection to the network device. Note that, the first wired connection and the second wired connection may be aggregated using a Link Aggregation Control Protocol (LACP).

Selecting mechanism 670 generally selects a wired uplink connection for transmitting a particular data set. Specifically, selecting mechanism 670 can select one of the first wired connection and the second wired connection for transmitting each subset of the first data set based on a client device from which that subset of the first data set was received. In particular, selecting mechanism 670 can select one of the first wired connection and the second wired connection for transmitting each subset of the first data set based on an Association Identification (AID) of a client device from which that subset of the first data set was received. In some embodiments, selecting mechanism 670 can select one of the first wired connection and the second wired connection for transmitting each subset of the first data set using packet-based load balancing algorithm that balances a plurality of data sets transmitted from the access point to the network device across a plurality of wired connections between the access point and the network device.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A non-transitory computer readable medium comprising instructions which, when executed by one or more hardware processors, causes performance of operations comprising:
receiving, by an access point, a first data set using a particular radio of a plurality of radios;
transmitting, by the access point, the first data set to a network device by:
transmitting, by the access point to the network device, a first subset of the first data set using a first wired connection between the access point and the network device;
transmitting, by the access point to the network device, a second subset of the first data set using a second wired connection between the access point and the network device.

2. The medium of claim 1, wherein the operations further comprise:
receiving, by the access point, a second data set using a second radio of the plurality of radios;
transmitting, by the access point to the network device, the second data set using only one of the first wired connection between the access point and the network device or the second wired connection between the access point and the network device.

3. The medium of claim 2, wherein the first subset of the first data set is transmitted using a first wired connection via a first encapsulation tunnel, wherein the second subset of the first data set is transmitted using the second wired connection via a second encapsulation tunnel, and wherein the second data set is transmitting using the second wired connection via a third encapsulation tunnel.

4. The medium of claim 1, wherein the first subset of the first data set corresponds to data received from a first set of client devices and wherein the second subset of the first data set corresponds to data received from a second set of client devices.

5. The medium of claim 1, wherein the operations further comprise selecting one of the first wired connection and the second wired connection for transmitting each subset of the first data set based on a client device from which that subset of the first data set was received.

6. The medium of claim 1, wherein the operations further comprise selecting one of the first wired connection and the second wired connection for transmitting each subset of the first data set based on an Association Identification of a client device from which that subset of the first data set was received.

7. The medium of claim 1, wherein transmitting the first subset of the first data set comprises transmitting from a first physical port on the access point over the first wired connection to the network device, and wherein transmitting the second subset of the first data set comprises transmitting from a second physical port on the access point over the second wired connection to the network device.

8. The medium of claim 7, wherein the first wired connection and the second wired connection are aggregated using a Link Aggregation Control Protocol (LACP).

9. The medium of claim 1, wherein the operations further comprise selecting one of the first wired connection and the second wired connection for transmitting each subset of the first data set using a load balancing algorithm that balances a plurality of data sets transmitted from the access point to the network device across a plurality of wired connections between the access point and the network device.

10. The medium of claim 1,
wherein the first subset of the first data set identifies a first Internet Protocol (IP) address corresponding to the access point as a source address and a second IP address as a destination address;
wherein the second subset of the first data set identifies the first Internet Protocol (IP) address corresponding to the access point as the source address and a third IP address as a destination address;
wherein second IP address and the third IP address correspond to a same device.

11. An access point comprising:
at least one hardware processor;
the access point being configured to perform operations comprising:
receiving a first data set using a particular radio of a plurality of radios;
transmitting the first data set to a network device by:
transmitting, to the network device, a first subset of the first data set using a first wired connection between the access point and the network device;
transmitting, to the network device, a second subset of the first data set using a second wired connection between the access point and the network device.

12. The access point of claim 11, wherein the operations further comprise:
receiving, a second data set using a second radio of the plurality of radios;
transmitting, to the network device, the second data set using only one of the first wired connection between the access point and the network device or the second wired connection between the access point and the network device.

13. The access point of claim 12, wherein the first subset of the first data set is transmitted using a first wired connection via a first encapsulation tunnel, wherein the second subset of the first data set is transmitted using the second wired connection via a second encapsulation tunnel, and wherein the second data set is transmitting using the second wired connection via a third encapsulation tunnel.

14. The access point of claim 11, wherein the first subset of the first data set corresponds to data received from a first set of client devices and wherein the second subset of the first data set corresponds to data received from a second set of client devices.

15. The access point of claim 11, wherein the operations further comprise selecting one of the first wired connection and the second wired connection for transmitting each subset of the first data set based on a client device from which that subset of the first data set was received.

16. The access point of claim 11, wherein the operations further comprise selecting one of the first wired connection and the second wired connection for transmitting each subset of the first data set based on an Association Identification of a client device from which that subset of the first data set was received.

17. The access point of claim 11, wherein transmitting the first subset of the first data set comprises transmitting from a first physical port on the access point over the first wired connection to the network device, and wherein transmitting the second subset of the first data set comprises transmitting from a second physical port on the access point over the second wired connection to the network device.

18. The access point of claim 17, wherein the first wired connection and the second wired connection are aggregated using a Link Aggregation Control Protocol (LACP).

19. The access point of claim 11, wherein the operations further comprise selecting one of the first wired connection and the second wired connection for transmitting each subset of the first data set using a load balancing algorithm that balances a plurality of data sets transmitted from the access point to the network device across a plurality of wired connections between the access point and the network device.

20. The access point of claim 11,
wherein the first subset of the first data set identifies a first Internet Protocol (IP) address corresponding to the access point as a source address and a second IP address as a destination address;
wherein the second subset of the first data set identifies the first Internet Protocol (IP) address corresponding to the access point as the source address and a third IP address as a destination address;
wherein second IP address and the third IP address correspond to a same device.
